(19) United States
(12) Patent Application Publication
(10) Pub. No.: US 2003/0058745 A1
(43) Pub. Date: Mar. 27, 2003

(54) Watchband and ring

(76) Inventor: Shimako Vizcarra, Piscataway, NJ (US)

Correspondence Address: Mr. Walter J. Tencza Jr., Suite 3, 10 Station Place, Metuchen, NJ, 08840, US

(21) Appl. No.: 09/962,182

(22) Filed: Sep. 25, 2001

(51) Int. Cl. G04B 37/00

(52) U.S. Cl. 368/282

(57) ABSTRACT

The present invention discloses a method comprising taking a watch having a time piece and a watchband, taking the time piece off of the watch, and connecting the watchband together in a closed loop to form a ring. The watchband may be comprised of a plurality of band members and a plurality of link members, wherein each of the band members is rotatably connected to two link members. The ring may be adapted to be about the size of the circumference of an individual's finger. A method is also disclosed of making a watch having a watchband of a first type and a timepiece and making a ring of the same type as the watchband. The method may be further comprised of wearing the watch on a wrist of an individual and simultaneously wearing the ring on a finger of the same individual. A ring is also disclosed comprising a plurality of band members, a plurality of link members, and a plurality of screws connected together in a closed loop.

### FIELD OF THE INVENTION

This invention relates to improved methods and apparatus concerning watchbands and rings.

### BACKGROUND OF THE INVENTION

Typically in the prior art watchbands and rings are made of different materials and in different manners. Typically watchbands and rings do not coordinate with each other.

### SUMMARY OF THE INVENTION

The present invention in one embodiment discloses a method comprising taking a watch having a time piece and a watchband, taking the time piece off of the watch, and connecting the watchband together in a closed loop to form a ring. The method may be further comprised of a plurality of band members and a plurality of link members, wherein each of the band members is rotatably connected to two link members. The ring may be adapted to be about the size of the circumference of an individual's finger.

The present invention in one embodiment also discloses a method comprised of making a watch having a watchband of a first type and a timepiece and making a ring of the same type as the watchband. The method may further comprise wearing the watch on a wrist of an individual and simultaneously wearing the ring on a finger of the same individual.

The present invention in one embodiment also discloses an apparatus comprising a plurality of band members, a plurality of link members, and a plurality of screws. Each of the plurality of band members may be rotatably connected to two of each of the plurality of link members by two of the plurality of screws. Each of the plurality of link members may be rotatably connected to two of each of the plurality of band members by two of the plurality of screws. Instead of screws, push pins can be used or a mixture of screws and push pins or other known connection devices which allow rotation. The plurality of link members and the plurality of band members are connected in a closed loop.

The present invention contemplates any type of link members and/or band members or any type of link or band generally that is made into a ring to match a watch band. In this broad embodiment of the invention the particular style, shape, or material that is used for the watch, band, or ring does not matter, as long as the ring matches the watch band.

### BRIEF DESCRIPTION OF THE DRAWINGS

FIG. 1 shows a front view of a ring in accordance with an embodiment of the present invention where the ring is in a flattened state;

FIG. 2 shows a side view of the ring of FIG. 1 in the flattened state;

FIG. 3 shows a top view of the ring of FIG. 1 in the flattened state;

FIG. 4 shows a side view of the ring of FIG. 1 where the ring is in a substantially circular state for placing on a person's finger; and

FIG. 5 shows a side view of a prior art watch with which the ring of FIG. 1 can be combined or from which the ring of FIG. 1 can be made in accordance with an embodiment of the present invention.

### DETAILED DESCRIPTION OF THE DRAWINGS

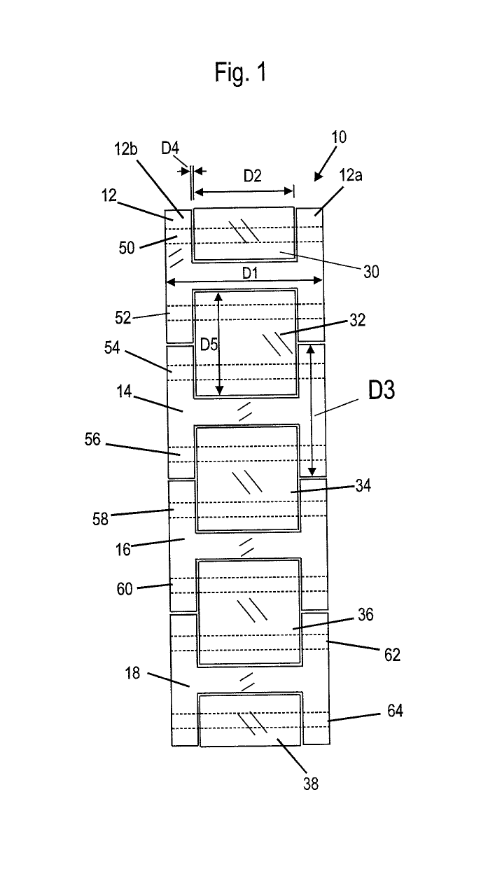

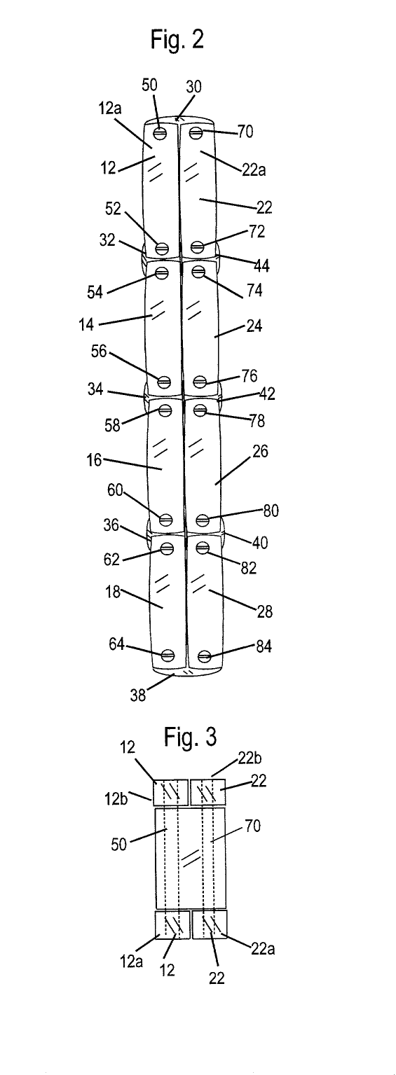

FIG. 1 shows a front view of a ring 10 in accordance with an embodiment of the present invention where the ring 10 is in a flattened state. FIG. 2 shows a side view of the ring 10 of FIG. 1 in the flattened state. FIG. 3 shows a top view of the ring 10 of FIG. 1 in the flattened state.

The ring 10 has a includes members 12, 14, 16, and 18 which are shaped in the form of an “H” and are shown in FIG. 1 and their counterpart opposing members 22, 24, 26, and 28, which are also shaped in the form of an “H” and are partially shown in FIG. 2. The members 12-18 and 22-28 can be called band members. The back view of the ring 10 looks the same as the front view of the ring 10 in FIG. 1 except different components would be seen. For example, instead of members 12-18 at the front view, one would see members 22-28 at the back view of the ring 10.

Each H-shaped member of members 12-18 and 22-28, may have a width of D1, shown in FIG. 1, which may be ⅜ (three eighths of an inch) and a height D3 which may be about 2/8 (two eighths) of an inch.

The ring 10 also includes link members 30, 32, 34, 36, and 38 shown in FIG. 1, and link members 40, 42, and 44 shown in FIG. 2. Each link member of link members 30-44 may have a width of D2 which may be about 2/8 (two eighths) of an inch and a height of D5 which may be about 3/16 (three sixteenths) of an inch. There is a separation D4, which is very small, between the posts 12b and 12a of H-shaped member 12 and link member 30. There is a similar separation for all of the other band or H-shaped members 14-18 and 22-28 and their adjacent link members of members 32-44. The ring 10 also includes screws or shafts 50, 52, 54, 56, 58, 60, 62, 64, 70, 72, 74, 76, 78, 80, 82, and 84 shown in FIG. 2, and some of which are shown by dashed lines in FIG. 1 and FIG. 3. Each link member of link members 30-44 along with two screws of screws 50-84 connects two H-shaped members together. For example, as shown in FIG. 2, H-shaped member 12 and H-shaped member 22 are connected together by screw 50, link member 30, and screw 70. More specifically screw 50 passes through a hole in H-shaped member 12 and a hole in link member 30 so that H-shaped member 12 is rotatably connected to link member 30. Screw 70 passes through a hole H-shaped member 22 and a hole in link member 30 so that H-shaped member 22 is rotatably connected to link member 30.

Similarly referring to FIGS. 1-3, H-shaped members 12 is rotatably connected by screw 52 to link member 32, H-shaped member 14 is rotatably connected by screws 54 and 56 to link members 32 and 34 respectively, H-shaped member 16 is rotatably connected by screws 58 and 60 to link members 34 and 36, respectively, H-shaped member 18 is rotatably connected by screws 62 and 64 to link members 36 and 38, respectively, H-shaped member 22 is rotatably connected by screws 70 and 72 to link members 30 and 44, respectively, H-shaped member 24 is rotatably connected by screws 74 and 76 to link members 44 and 42, respectively, H-shaped member 26 is rotatably connected by screws 78 and 80 to link members 42 and 40, respectively, and H-shaped member 28 is rotatably connected by screws 82 and 84 to link members 40 and 38, respectively,

The band members 12-18 and 22-28 are connected in a closed loop by link members 30-44 and screws 50-84.

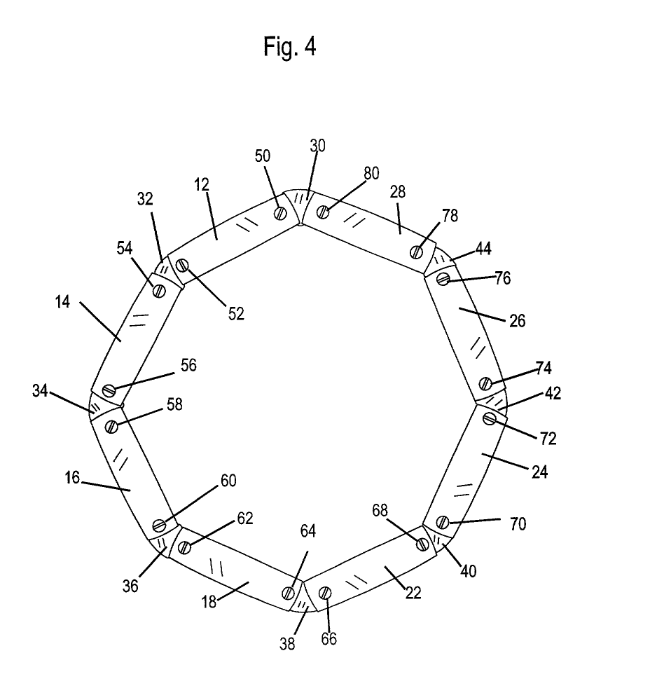

The rotatable connections described allow the different H-shaped members to rotate with respect to adjacent H-shaped members allowing the ring 10 to be put into different states such as the flattened state of FIG. 1 and a substantially circular state which is shown in FIG. 4. The ring 10 can be placed on an individual's finger in the state of FIG. 4.

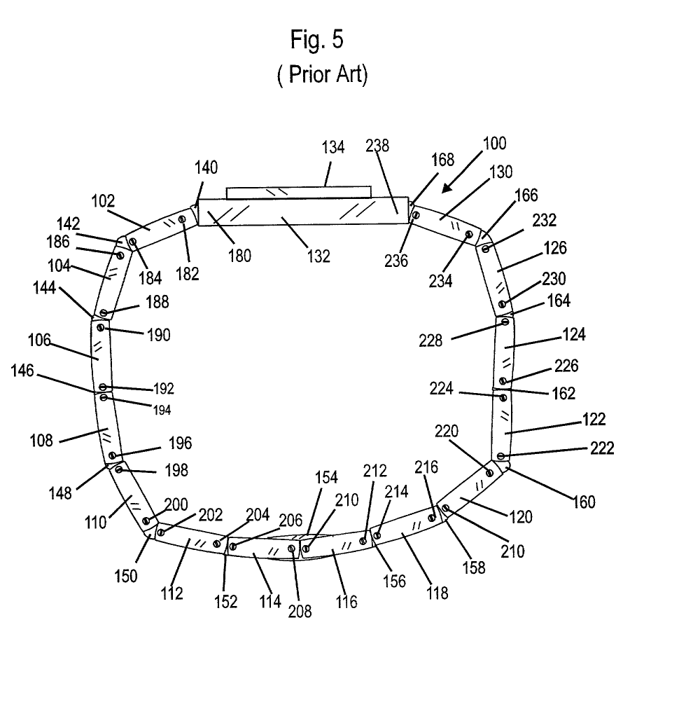

FIG. 5 shows a side view watch 100 with which the ring 10 of FIG. 1 can be combined with or from which the ring 10 of FIG. 1 can be made in accordance with an embodiment of the present invention. The watchband structure of the watch 100 is known in the art. However, it is not known to use this watchband structure for a ring as in FIG. 1. It is also not known to combine a watch band structure such as for watch 100 with a similar ring structure as for ring 10 in FIG. 1.

The watch 100 has a watch band structure which is comprised of H-shaped members 102-130, link members 140-168, and screws 180-238. The members 102-130 can be called band members. The watch 100 is also comprised of main member 132 and a time piece 134 which shows the time and/or date. The H-shaped members 102-130, link members 140-168, and screws 180-238 are connected in a similar manner to that described with reference to FIG. 1. The watch 100 also includes a clasp device 154 which allows the watch 100 to be opened in a known manner.

The ring 10 can be derived from the watch 100 by simply using some of the same type of H-shaped members of 102-130, link members 140-168, and screws 180-238, to construct the ring 10. The H-shaped members 102-130 may each be identical to each of the H-shaped members 12-18 and 22-28 of FIG. 1 and FIG. 2. The link members 140-168 may each be identical to each of the link members 30-44. The screws 18-238 may each be identical to each of the screws 50-84. The ring 10 can be formed from the watch 100 by taking the main member 132 and time piece 134 off of the watch 100 and then linking at least some of the remaining members together to form a ring, i.e. a closed loop, and then using the remaining members as a ring.

The present invention includes deriving a ring from many different types of watch band structures and combining the derived ring with the watch band structure from which it derived. For example, in operation, in accordance with a method of the present invention a person may place both the watch 100 and the ring 10 on their person at the same time to have coordinated pieces of jewelry. The person may place the watch 100 on their wrist in a typical manner and may place the ring 10 on one of their fingers. The watch 100 and ring 10 may then be worn at the same time. Various types of materials for the watchband structure of the watch 100 and the ring 10 may be made of eighteen karat gold over sterling silver, base metal, stainless steel, ten karat gold, fourteen karat gold, eighteen karat gold, twenty-two karat gold, twenty-four karat gold, platinum, rubber, plastic, or sterling silver. The link members, such as 30-44, may be slightly smaller than the actual link members 140-168 of a watch. The H-shaped members (which broadly can also be termed link members) 12-18 and 22-28 of the ring 10 may also be slightly smaller than the members 102-130 of watch 100 but in accordance with the present invention ring 10 is of the same style as the watch band of watch 100 even if somewhat reduced in size.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising:
taking a watch having a time piece and a watchband;
taking the time piece off of the watch; and
connecting the watchband together in a closed loop to form a ring.

2. The method of claim 1 wherein
the watchband is comprised of a plurality of band members and a plurality of link members;
wherein each of the band members is rotatably connected to two link members.

3. The method of claim 1 wherein
the ring is adapted to be about the size of the circumference of an individual's finger.

4. A method comprised of
making a watch having a watchband of a first type and a timepiece; and
making a ring of the same type as the watchband.

5. The method of claim 4 further comprising
wearing the watch on a wrist of an individual;
and simultaneously wearing the ring on a finger of the same individual.

6. An apparatus comprising
a plurality of band members;
a plurality of link members;
a plurality of screws;
wherein each of the plurality of band members is rotatably connected to two of each of the plurality of link members by two of the plurality of screws;
wherein each of the plurality of link members is rotatably connected to two of each of the plurality of band members by two of the plurality of screws;
and wherein the plurality of link members and the plurality of band members are connected in a closed loop.
